(19) United States
(12) Patent Application Publication
(10) Pub. No.: US 2023/0125655 A1
(43) Pub. Date: Apr. 27, 2023

(54) ELECTROSTATIC ZIPPER WITH IONOELASTOMER MEMBRANES FOR DECREASED OPERATING VOLTAGE

(71) Applicant: META PLATFORMS TECHNOLOGIES, LLC, Menlo Park, CA (US)

(72) Inventors: Tianshu Liu, Redmond, WA (US); Li Yao, Redmond, WA (US); Wenyang Pan, Redmond, WA (US); Jitkanya Wong, Everett, WA (US)

(21) Appl. No.: 17/735,957

(22) Filed: May 3, 2022

Related U.S. Application Data
(60) Provisional application No. 63/271,914, filed on Oct. 26, 2021.

(51) Int. Cl. H02N 1/00; G06F 3/01

(52) U.S. Cl. CPC H02N 1/002; G06F 3/016; G06F 3/011

(57) ABSTRACT

An actuatable device includes a first ionoelastomer membrane disposed over and locally spaced away from a second ionoelastomer membrane, the first and second ionoelastomer membranes defining a dielectric fluid-containing reservoir therebetween, a primary electrode overlying a portion of the first ionoelastomer membrane, and a secondary electrode overlying a portion of the second ionoelastomer membrane.

### CROSS-REFERENCE TO RELATED APPLICATION

This application claims the benefit of priority under 35 U.S.C. § 119(e) of U.S. Provisional Application No. 63/271,914, filed Oct. 26, 2021, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a series of schematic views showing the manufacture and operation of an electrostatic zipping actuator according to various embodiments.

FIG. 2 is a schematic cross-sectional view showing the charge distribution within the zipped section along an ionoelastomer-ionoelastomer interface during the operation of an electrostatic zipping actuator according to some embodiments.

FIG. 3 depicts schematic illustrations of an ionoelastomer heterojunction including adjacent polycation and polyanion domains operated under reverse and forward bias according to certain embodiments.

FIG. 4 shows cross-sectional illustrations of an electrostatic zipping tactile actuator according to further embodiments.

FIG. 5 is a cross-sectional illustration of an electrostatic zipping tactile actuator having electrode and ionoelastomer membranes located within an insulative pouch according to certain embodiments.

FIG. 6 is a schematic illustration of an electrostatic zipping shear actuator according to certain embodiments.

FIG. 7 is a schematic illustration of an electrostatic kinesthetic actuator according to certain embodiments.

FIG. 8 illustrates the operation of an electrostatic zipping squeeze actuator according to some embodiments.

FIG. 9 is a schematic illustration of an electrostatic zipping peristaltic pump according to certain embodiments.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure.

FIG. 12 is an illustration of exemplary haptic devices that may be used in connection with embodiments of this disclosure.

FIG. 13 is an illustration of further exemplary haptic devices that may be used in connection with embodiments of this disclosure.

FIG. 14 is an illustration of an exemplary virtual-reality environment according to embodiments of this disclosure.

FIG. 15 is an illustration of an exemplary augmented-reality environment according to embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is directed generally to electrostatically driven devices and more particularly to electrostatic actuators, i.e., zipping actuators, and their methods of manufacture and use. Example electrostatic actuators may include a dielectric fluid-filled pouch (reservoir) sandwiched between opposing membranes and a conductive electrode overlying each respective membrane. In particular embodiments, the membranes may each include an ionoelastomer and, during operation of the actuator, the membranes may form a heterojunction between polycation and polyanion domains.

Electrostatic zipping actuators operate in accordance with Coulomb's Law where the electrostatic force between oppositely charged electrodes is inversely proportional to the square of the distance between the electrodes. A comparative zipping actuator may include paired electrodes disposed in an opposing, overlapping manner and separated by dielectric membranes that may be reversibly drawn together or forced apart by applying a suitable inter-electrode bias (voltage). The realized force (F) between the electrodes may be expressed as

$$F \sim \frac{ϵ {V}^{2}}{{d}^{2}} ,$$

where ϵ is the effective dielectric constant of the membranes, V is the applied voltage, and d is the distance between the electrodes. Electrostatic zipping actuators may be implemented in various devices, including fluid valves, tactile actuators, kinesthetic actuators, shear actuators, and peristaltic pumps where high forces and large displacements are typically desired.

Although a desirably greater attractive force, e.g., a force effective to secure the actuator in a closed or zipped state, may be achieved merely by increasing the magnitude of the applied voltage, at higher working voltages such actuators may be prone to dielectric breakdown or electrical short circuits that decrease reliability and may lead to failure in the field. Furthermore, higher working voltages may require large and heavy power and control electronics that may limit the wearability of the device. Notwithstanding recent developments, the realization of high reliability, mechanically robust electrostatic actuators capable of rapid and repeated actuation at lower applied voltages would be beneficial.

In accordance with various embodiments, operation of electrostatic zipping actuators that are driven by low voltage and capable of exerting large pressures may be achieved by locating a pair of ionoelastomer membranes between the electrodes. The ionoelastomer membranes may define a polycation-polyanion junction. In an unzipped state, the membranes may define an intervening pouch that is at least partially filled with a dielectric fluid. In example actuators, each ionoelastomer membrane may directly contact the dielectric fluid.

As disclosed further herein, under an applied reverse bias (where the polycation domain is connected to the positive terminal of an associated power supply and the polyanion domain is connected to the negative terminal), the voltage drop across an ionic double layer may provide electrostatic attraction between the adjacent ionoelastomer membranes. The associated zipping of the membrane pair may reconfigure the shape of the intervening dielectric fluid, which may generate a tactile output or applied force. Under an applied forward bias, on the other hand, mobile ions may accumulate at the interface, decrease the contact interface resistance, and weaken the electric field, which may allow the actuator to unzip or the applied force to be unapplied.

By replacing the dielectric membranes used in comparative zipping actuators with a pair of conductive ionoelastomer membranes, a majority of the charge in a biased actuator may accumulate at the contact interface between the adjacent ionoelastomer layers instead of at the surfaces of the respective electrodes, which may enable operation at a lower applied voltage. The total attractive force (F) between ionoelastomer-electrode composites may be represented as

$$F \sim \frac{{ϵ}_{C} {V}^{2}}{{d}_{C}^{2}} ,$$

where ε_{c} is the dielectric constant of the contact interface and d_{c} is the contact interface gap, which is typically on the order of a few to tens of nanometers.

One of the ionoelastomer membranes may include a polyanion domain while the other may include a polycation domain. During operation and under a reverse bias, only positive charges are free to move within the polyanion domain, whereas negative charges are fixed by polymer chains. In a similar vein, within the polycation domain, only negative charges are free to move. With the mobile ions drawn away from the ionoelastomer contact interface, the interface resistance is very high even though the ionoelastomer membranes themselves are conductive.

A variety of materials may be used to form the constituent elements of such an actuator. In the case of the electrodes and in embodiments where a single electrode is configured to zip and unzip, the opposing electrode may include a substantially rigid conductive substrate, such as a metal or a doped semiconductor. In such embodiments or in embodiments where both electrodes are configured to zip and unzip, one or both of the electrodes may include, for example, a thin (˜50 nm) metal layer, a layer of microporous layer carbon, or a conductive polymer such as doped polydimethylsiloxane (PDMS). That is, one or more of the zipping electrodes may include a mechanically compliant or substantially mechanically compliant material.

In some examples, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least 90% met, at least 95% met, or even at least 99% met.

The electrodes may be microporous, which may generate a large electrode-ionoelastomer interfacial capacitance. In some embodiments, the electrodes may be conformal such that the contact resistance between each electrode and its adjacent ionoelastomer membrane is negligible. In either case, during operation, the voltage drop across an example actuator may be realized at the ionoelastomer-ionoelastomer contact interface rather than at an electrode-ionoelastomer interface.

The electrodes in some embodiments may be configured to stretch elastically. In some embodiments, an electrode may include a polymer composite including a low surface tension polymer matrix having conductive particles, e.g., carbon black, dispersed throughout the matrix. The polymer matrix may include silicones, acrylates, silicone-acrylates, and other elastomers. Example low surface tension polymers may include poly(tetrafluoroethylene), polyvinylidene fluoride, or poly(dimethyl siloxane). Further example electrodes may include poly(3,4-ethylenedioxythiophene) polystyrene sulfonate (PEDOT:PSS).

Conductive (doped) polydimethylsiloxane (cPDMS) may be manufactured by dispersing conductive particles (e.g., flakes, nanorods, etc.) throughout the matrix of a PDMS polymer. Further example electrodes may include one or more electrically conductive materials, such as a metal, carbon nanotubes, graphene, oxidized graphene, fluorinated graphene, hydrogenated graphene, other graphene derivatives, carbon black, and the like. The conductive particles may include metal nanoparticles, metal nanowires, graphene nanoparticles, graphene flakes, transparent conductive oxide nanoparticles, and the like. In some embodiments, the electrodes may have an electrical conductivity of at least approximately 1 S/cm.

In certain embodiments, an electrode such as a compliant electrode, may have an average thickness of from approximately 50 nm to approximately 500 micrometers, e.g., approximately 50 nm, approximately 100 nm, approximately 200 nm, approximately 500 nm, approximately 1 micrometer, approximately 2 micrometers, approximately 5 micrometers, approximately 10 micrometers, approximately 20 micrometers, approximately 50 micrometers, approximately 100 micrometers, approximately 200 micrometers, or approximately 500 micrometers, including ranges between any of the foregoing values.

The ionoelastomer membranes may include an organic ionoelastomer material such as a crosslinked network of 1-ethyl-3-methyl imidazolium poly[(3-sulfopropyl) acrylate] (ES) or poly [1-(2-acryloyloxyethyl)-3-buthylimidazolium]bis(trifluoromethane) sulfonimide (AT), although further ionoelastomer materials are contemplated. In some examples, the ionoelastomer membranes may be mechanically reinforced through the addition of an inorganic additive, such as particles of fumed silica.

An average thickness of each ionoelastomer membrane may be less than approximately 500 micrometers, e.g., less than approximately 300 micrometers. In certain embodiments, the average thickness of each ionoelastomer membrane may independently range from approximately 200 nm to approximately 300 micrometers, e.g., approximately 200 nm, approximately 500 nm, approximately 1 micrometer, approximately 2 micrometers, approximately 5 micrometers, approximately 10 micrometers, approximately 20 micrometers, approximately 50 micrometers, approximately 100 micrometers, approximately 200 micrometers, or approximately 300 micrometers, including ranges between any of the foregoing values.

In some embodiments, the line tension within the ionoelastomer membranes may be less than approximately 50 N/m, e.g., 5, 10, 20, or 50 N/m, including ranges between any of the foregoing values. Higher line tension may favorably decrease incidences of sticking between adjacent membranes during unzipping. That is, sufficient line tension within the ionoelastomer membranes may promote debonding of the ionoelastomer membranes from each other, i.e., in an off or unbiased state.

The dielectric fluid may include silicone oil or fluorinated fluids, although additional dielectric fluid compositions such as dielectric esters may be used. The dielectric fluid may include a liquid or a gas. The dielectric fluid may include a compressible fluid or an incompressible fluid. In some embodiments, the dielectric fluid may operate as a lubrication layer to decrease the off-state adhesion between the ionoelastomer membranes.

In certain embodiments, the disclosed electrostatic zipping actuators may generate a pressure upon actuation of up to approximately 200 kPa at operating voltages of less than approximately 50V. For instance, a generated pressure may be approximately 5 kPa, approximately 10 kPa, approximately 20 kPa, approximately 50 kPa, approximately 100 kPa, or approximately 200 kPa, including ranges between any of the foregoing values. An operating voltage may be approximately 2V, approximately 3V, approximately 4V, approximately 5V, approximately 10V, approximately 20V, or approximately 50V, including ranges between any of the foregoing values.

An actuatable device may include a polyanion ionoelastomer membrane disposed over and locally spaced away from a polycation ionoelastomer membrane, the ionoelastomer membranes defining a dielectric fluid-containing reservoir therebetween, a primary electrode overlying a portion of the polyanion ionoelastomer membrane, and a secondary electrode overlying a portion of the polycation ionoelastomer membrane.

According to a further embodiment, an insulative pouch may envelop the dielectric fluid-containing reservoir as well as the electrode-ionoelastomer membrane composites.

Features from any of the embodiments described herein may be used in combination with one another in accordance with the general principles described herein. These and other embodiments, features, and advantages will be more fully understood upon reading the following detailed description in conjunction with the accompanying drawings and claims.

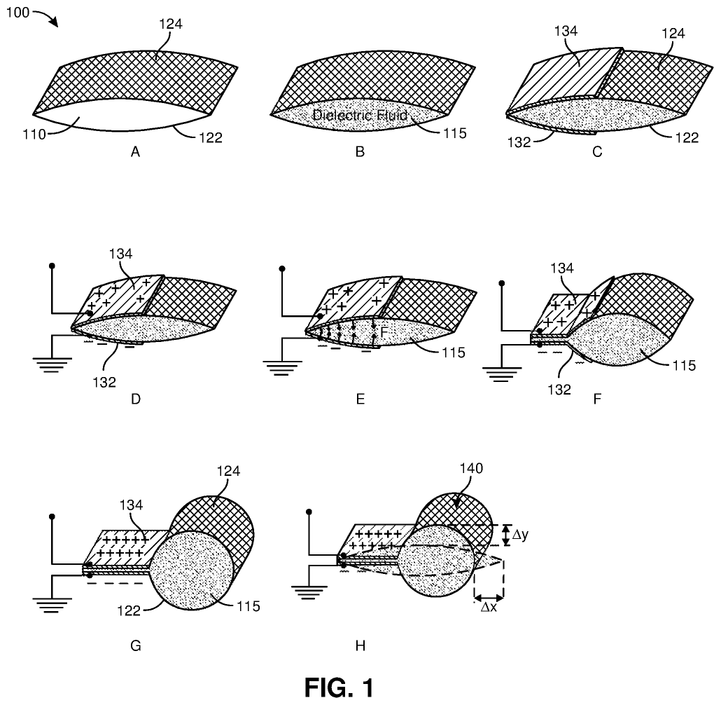

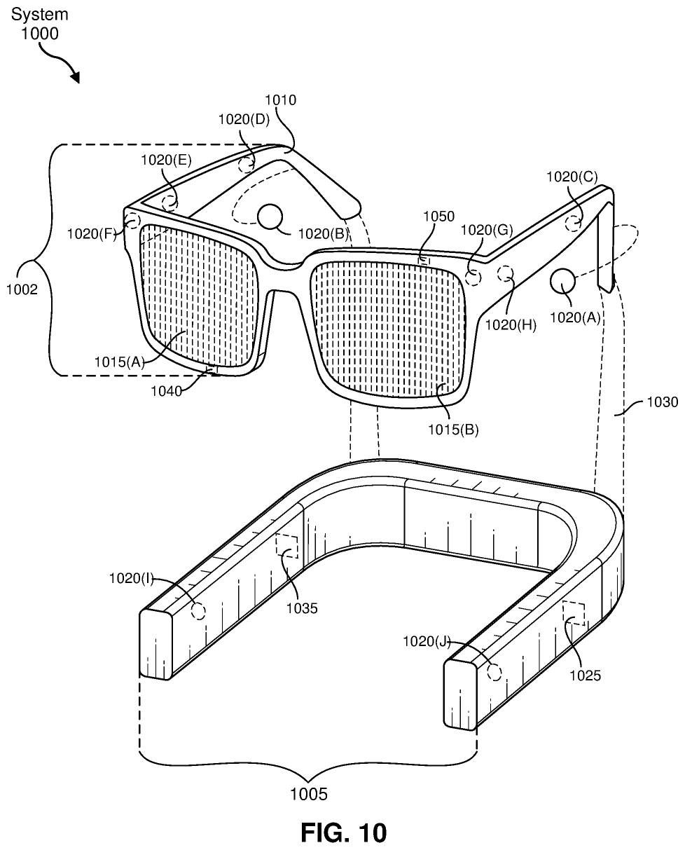

The following will provide, with reference to FIGS. 1-15, detailed descriptions of electrostatically driven actuators and devices including such actuators. The discussion associated with FIGS. 1-9 includes a description of electrostatic zipping actuator structures and example methods of manufacture. The discussion associated with FIGS. 10-15 relates to exemplary virtual reality and augmented reality devices that may include an electrostatically driven actuator as disclosed herein.

An electrostatic zipping actuator may include a pair of conductive electrodes and a pair of ionoelastomer membranes sandwiched between the electrodes and defining a dielectric fluid-filled pouch therebetween. An example method 100 of forming such a zipping actuator as well as the resulting structure and principle of operation are shown schematically in FIG. 1.

Referring to FIG. 1A, a pouch (reservoir) 110 is defined between an opposing pair of ionoelastomer membranes 122, 124. As shown in FIG. 1B, the pouch may be filled with a dielectric fluid 115 and, as shown in FIG. 1C, respective electrodes (e.g., a primary electrode 132 and a secondary electrode 134) may be formed over portions of the lower and upper ionoelastomer membranes.

Referring to FIG. 1D, by applying a bias to one or more of the electrodes (i.e., the primary electrode 132 and/or the secondary electrode 134), the attendant voltage gradient may create an electrostatic force (F) that induces mutual attraction between the electrode-ionoelastomer composites. The electrostatic force (F) is shown schematically in FIG. 1E and the associated impact on the shape of the actuator during the act of zipping is shown in FIG. 1F (partially zipped) and FIG. 1G (fully zipped). Because the ionoelastomer membranes are conductive, electrostatic attraction may extend between the ionoelastomer membranes rather than between the electrodes. Relative to the unbiased state, the impact of actuation on the shape of the fluid-filled pouch is shown in FIG. 1H. In some embodiments, an increased fluid pressure within the pouch may create a contraction (Δx) along an x-direction that may be used to exert an external force. In some embodiments, an increased fluid pressure within the pouch may create dilation (Δy) along a y-direction, causing an outer contact surface 140 to interact with the body part of a user.

The applied voltage may be a constant voltage or a periodically applied voltage. For instance, a pulsed drive scheme may be implemented, which may beneficially decrease the overall required operational power, and also decrease parasitic effects otherwise associated with the long-term application of an applied field between the two electrodes.

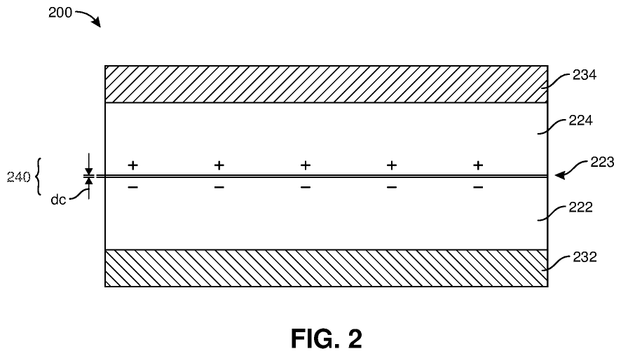

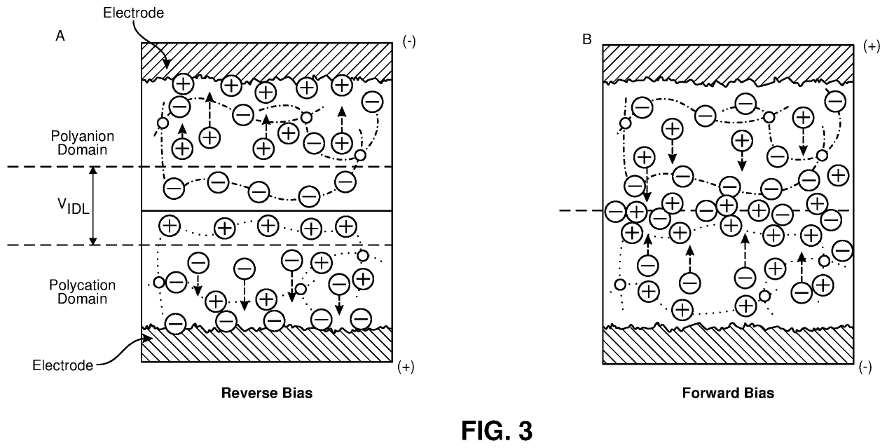

Referring to FIG. 2, shown schematically is an actuator architecture 200 including a primary electrode 232, a secondary electrode 234 overlying the primary electrode 232, and an opposing pair of ionoelastomer membranes 222, 224 located between the electrodes. Illustrated is the accumulation of net charges and the formation of an ionic double layer (IDL) 240 proximate the ionoelastomer-ionoelastomer interface 223, which is defined by an inter-membrane gap d_{c}. According to various embodiments, and with reference to FIG. 3, the voltage drop across the IDL may be modulated to reversibly control the extent of adhesion between the ionoelastomer membranes and accordingly the extent of the zipping. As shown in FIG. 3A, under an applied “reverse bias,” mobile ions may be drawn away from the interfacial region, leading to a build-up of excess fixed charges in the IDL. The electric field generated by the excess fixed charges may create strong electrostatic attraction between the two ionoelastomer membranes and an attendant “zipping” of the actuator. On the other hand, as shown in FIG. 3B, under “forward bias,” mobile cations may be driven from a polyanion domain into a polycation domain and mobile anions may be driven from the polycation domain into the polyanion domain. Accordingly, the interface may behave resistively and the electrostatic attraction between the two ionoelastomer membranes may be lost and the actuator may be “unzipped.”

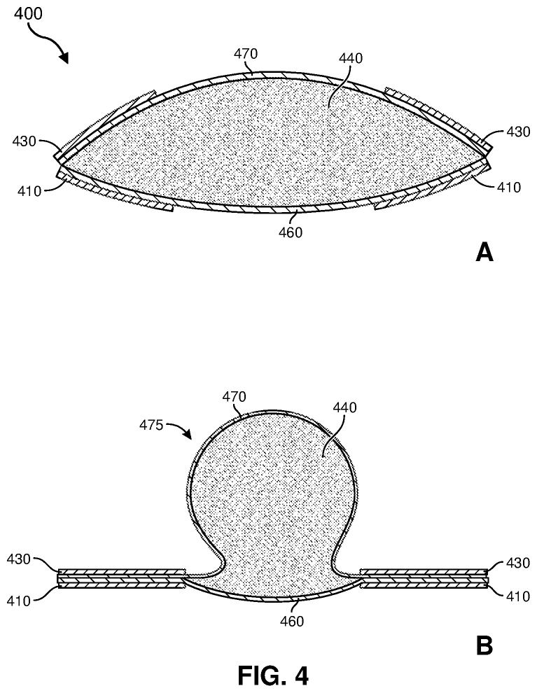

Aspects of a further example electrostatic zipping tactile actuator are illustrated in FIG. 4. Referring to FIG. 4A, electrostatic zipping actuator 400 may include segmented primary and secondary electrodes 410, 430 and compliant primary and secondary ionoelastomer membranes 460, 470, respectively, located between the electrodes 410, 430. Electrostatic zipping actuator 400 may further include a fixed volume of dielectric fluid 440 located between the primary membrane 460 and the secondary membrane 470. Referring to FIG. 4B, in examples where primary membrane 460 may be less compliant than secondary membrane 470, actuation of the zipping actuator 400 may compress dielectric fluid 440 and expand secondary membrane 470 creating a tactile bubble 475.

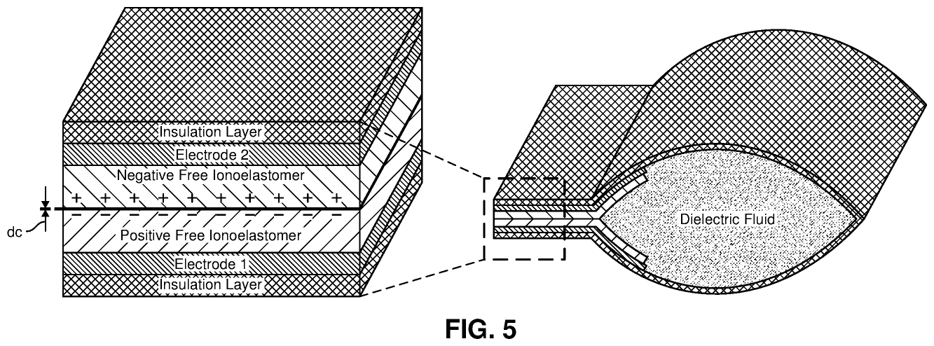

Referring to FIG. 5, according to a further embodiment, the dielectric fluid as well as the opposing electrode-ionoelastomer membrane composites may be contained within a sealed insulative pouch. During operation of such an actuator, applied stresses and the associated deformations may be directed principally to the insulative layers, rather than to the ionoelastomer membranes. In addition, with such a design, the body part of a user may come into contact with the insulative pouch rather than an ionoelastomer membrane or electrode.

As illustrated in FIG. 5, an electrostatic zipping actuator may include a first ionoelastomer membrane disposed over and locally spaced away from a second ionoelastomer membrane, the first and second ionoelastomer membranes defining a dielectric fluid-containing reservoir therebetween, a primary electrode overlying a portion of the first ionoelastomer membrane, a secondary electrode overlying a portion of the second ionoelastomer membrane, and an insulative layer enveloping the first and second ionoelastomer membranes as well as the primary and secondary electrodes. A portion of the insulative layer may include a first insulation layer overlying the primary electrode and a second insulation layer overlying the secondary electrode. In some embodiments, the first and second insulation layers may contain the dielectric fluid.

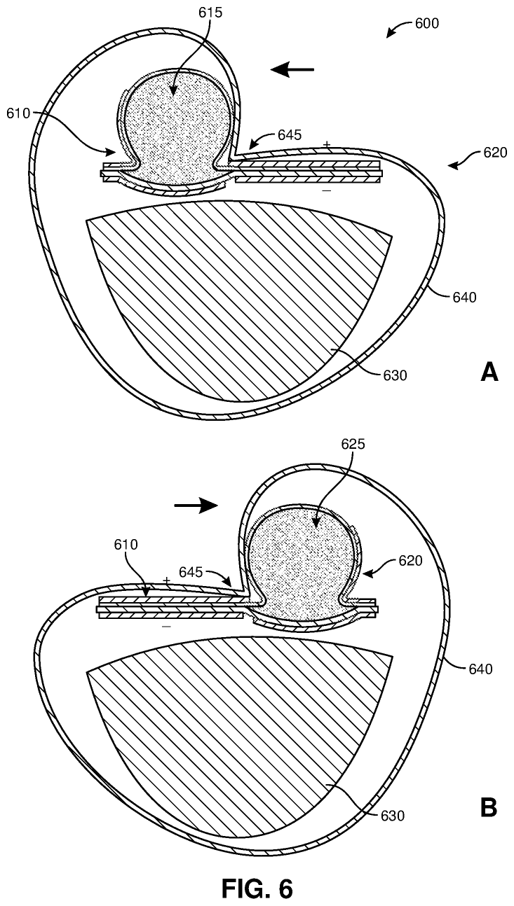

Two or more electrostatic zipping actuators may be configured to cooperatively operate as a wearable shear actuator. Referring to FIG. 6, shear actuator 600 may include a pair of connected electrostatic zipping actuators 610, 620 (e.g., electrostatic zipping actuators 400), for example, and may be affixed to the body part 630 of a user, such as a finger, using a removable strap 640. The strap 640 may be anchored at anchor point 645 to one or both of the electrostatic zipping actuators. Shear actuator 600 may be bi-directional and may be operated to induce a haptic sensation in the user's body part 630.

By way of example, in certain embodiments, electrostatic zipping actuators 610, 620 may be alternately actuatable. That is, in response to actuation and zipping of actuator 620, tactile bubble 615 associated with zipping actuator 610 may expand and pull strap 640 to the left such that the body part 630 feels a shear to the left (FIG. 6A). In response to actuation and zipping of zipping actuator 610, tactile bubble 625 associated with zipping actuator 620 may expand and pull strap 640 to the right such that the body part 630 experiences a shear to the right (FIG. 6B).

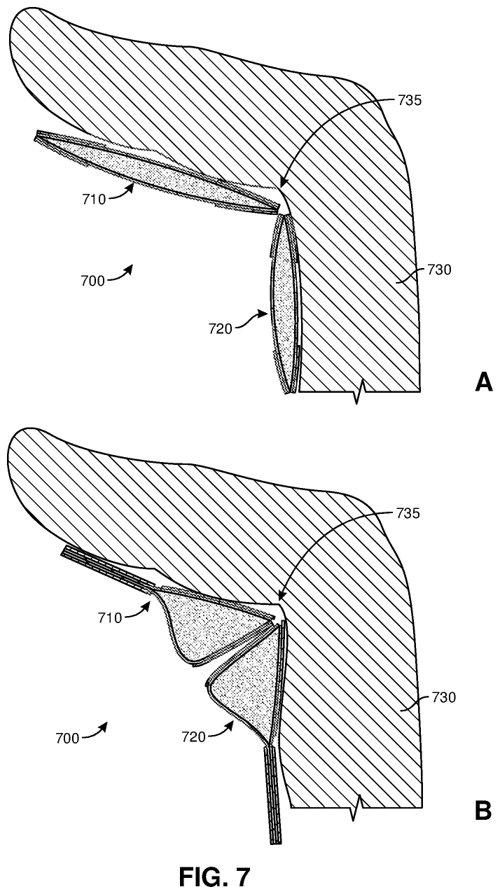

According to further embodiments, the electrostatic zipping actuators disclosed herein may be configured as kinesthetic actuators that apply force (e.g., torque) to the body part of a user, which may be used to simulate interaction with an object, such as in a virtual reality environment. That is, a kinesthetic actuator may generate a physical haptic response that creates for the user a sensation of interacting with a virtual object. Referring to FIG. 7, kinesthetic actuator 700 may include a pair of electrostatic zipping actuators 710, 720 (e.g., electrostatic zipping actuators 400) located proximate to the joint 735 of a user's body part 730. FIG. 7A shows actuators 710, 720 in an unactuated state. FIG. 7B shows actuators 710, 720 in an actuated state and the attendant application of pressure and torque to the joint 735 of body part 730.

The electrostatic zipping actuators are shown in FIG. 7 as being positioned at or proximate to joint portions of a user's body part 730, but other positions are also contemplated by the present disclosure. For example, an electrostatic zipping actuator may optionally be positioned along a side of a forefinger portion of a hand and adapted to be depressed by the user's thumb. In this position, the electrostatic zipping actuator may be configured as a user input button. Moreover, instead of or in addition to being positioned adjacent to a joint, the electrostatic zipping actuators may be positioned on a palm portion of a hand, on a wristband, on a shoe, on a headband, on a controller, etc. FIG. 7 illustrates a pair of electrostatic zipping actuators 710, 720 each at a joint portion of a user's hand. In additional embodiments, a lesser or greater number of electrostatic zipping actuators may be used.

One or more electrostatic zipping actuators may be incorporated into a device that is configured to be worn about the body part of a user where actuation of the electrostatic zipping actuator(s) may be used to reversibly adjust the fit of the device and/or provide haptic feedback to the user.

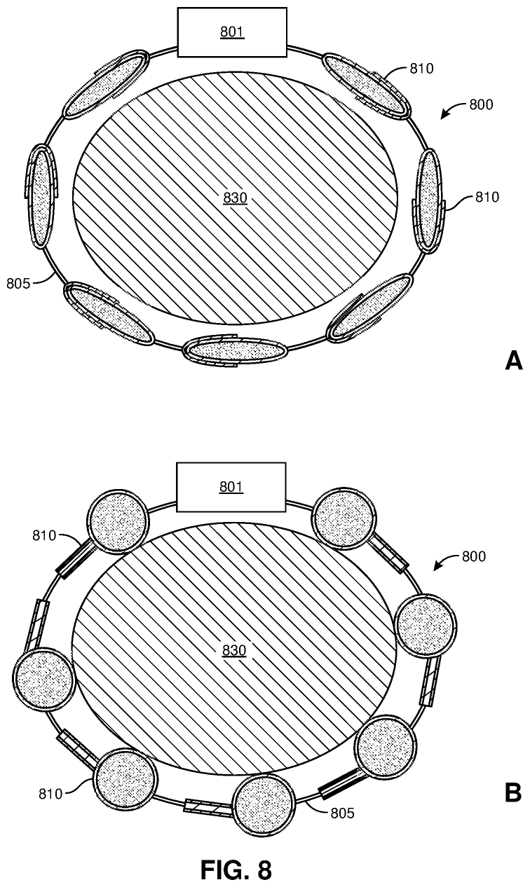

Referring to FIG. 8, wearable apparatus 800 may include any suitable configuration that fits about a user's body part. User body part 830 may represent any body part of a user including, for example, a leg, an ankle, an arm, a wrist, a finger, the neck, the waist, the chest, etc. Wearable apparatus 800 may include a band element 805, a device 801 attached to the band element 805 and a plurality of electrostatic zipping actuators 810 harnessed to the band element 805 along a perimeter thereof.

As illustrated in FIG. 8A, in an unactuated state, the band element 805 may fit loosely about the user's body part 830. Referring to FIG. 8B, after actuation, the total length of the band may be decreased due to the deformed shape of the fluid within the pouch of each actuator. The shortened band element 805 may compress body part 830. For example, actuation of the one or more electrostatic zipping actuators may cause the band element 805 to compress about the user's body part in a substantially uniform manner. Removing the actuation voltage may cause the device to release compression about the user's body part as shown in FIG. 8A. Each zipping actuator may be actuated individually, such that wrist-based tactile feedback can be provided to a user. High frequency content can also be applied individually to each zipping actuator, such that vibrotactile feedback can be rendered.

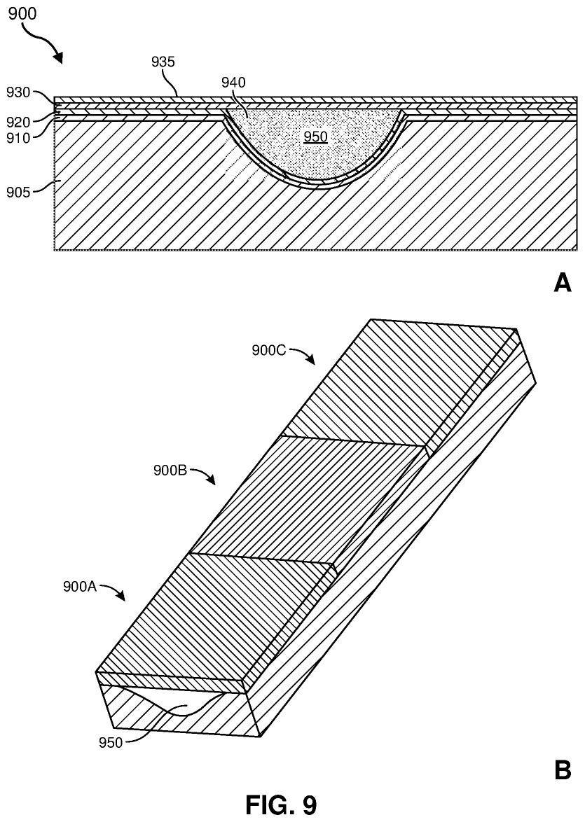

According to further embodiments, and as shown in FIG. 9, an electrostatic zipping actuator may be adapted to form a pump suitable for pumping liquids. Referring to FIG. 9A, electrostatic zipping actuator 900 may include, from bottom to top, a substrate 905, a primary electrode 910, a first ionoelastomer membrane 920, a second ionoelastomer membrane 930, and a secondary electrode 935. In particular embodiments, first and second ionoelastomer membranes 920, 930 may include oppositely charged mobile ions, and may include, for example, 1-ethyl-3-methyl imidazolium poly[(3-sulfopropyl) acrylate] (ES)-containing membrane and a poly [1-(2-acryloyloxyethyl)-3-buthylimidazolium]bis(trifluoromethane) sulfonimide (AT)-containing membrane, respectively.

In the illustrated embodiment, substrate 905 may include a flow channel 950. The primary electrode 910 and the first ionoelastomer membrane 920 may include layers that conformally overlie substrate 905, i.e., within flow channel 950. The electrostatic zipping actuator 900 may further include a dielectric fluid 940 located within flow channel 950 and proximate to the interface between the first ionoelastomer membrane 920 and the second ionoelastomer membrane 930.

Referring to FIG. 9B, a plurality of zipping actuators 900A, 900B, 900C may be arranged in series with aligned flow channels. In an example method, the zipping actuators 900A, 900B, 900C may be actuated in succession to advance (i.e., pump) air along the combined flow channel.

As disclosed herein, a zipping actuator operable at low voltages (V<50V) and capable of exerting high pressures (P>5 kPa) includes a dielectric fluid-filled pouch defined by opposing ionoelastomer membranes and an electrode pair (i.e., a primary electrode and a secondary electrode respectively overlying each membrane). In some examples, the dielectric fluid may be a compressible fluid or an incompressible fluid.

In particular embodiments, each ionoelastomer membrane, i.e., a conductive elastomeric polymer including ionic or ionizable functional groups, where one ion species may be anchored by the polymer network and the other species is mobile. Example ionoelastomer membranes may include cross-linked networks of 1-ethyl-3-methyl imidazolium poly[(3-sulfopropyl) acrylate] (ES) and poly [1-(2-acryloyloxyethyl) buthylimidazolium]bis(trifluoromethane) sulfonimide (AT).

The ionoelastomer membranes may be arranged as a polyanion-polycation heterojunction, i.e., a polyanion (ES)-polycation (AT) heterojunction. Because the ionoelastomer membranes are conductive, a majority of charge in a biased actuator may accumulate at the contact interface between the adjacent ionoelastomer membranes, which facilitates operation through a lower applied voltage. That is, when oppositely charged, an ionic double layer (IDL) may be formed at the interface between the ionoelastomer pair. The voltage drop across the IDL may be modulated to reversibly control the attraction between two ionoelastomer membranes.

In the example of an applied “reverse bias,” the mobile ions may be drawn away from the interfacial region, leading to a build-up of excess fixed charges in the IDL. The electric field generated by the excess fixed charges may induce strong electrostatic attraction between the two ionoelastomer membranes and an attendant “zipping” of the actuator. On the other hand, under “forward bias,” mobile cations may be driven from the polyanion domain into the polycation domain and mobile anions may be driven from the polycation domain into the polyanion domain. Accordingly, the interface may behave resistively and the electrostatic attraction between the two ionoelastomer membranes may be attenuated or lost and the actuator may be “unzipped.”

One or both of the electrodes may be flexible such that, under an applied voltage, an electrostatic force generated between the electrodes may draw the electrodes together or apart and correspondingly change the dimensions of the fluid-filled pouch. Example flexible electrodes may include microporous layer (MPL) carbon, a metal layer, or carbon-doped polydimethylsiloxane (cPDMS), although other flexible, conductive electrode materials are contemplated.

Using partial or full zipping, the zipping actuators may be used to form a valve or a peristaltic pump. In various haptics applications, the zipping actuators may be used to form a tactile bubble, a shear actuator, or a kinesthetic actuator that is configured to interact with the body part of a user. In still further embodiments, opposing arrays of zipping actuators may form an electrostatic motor, such as a linear synchronous machine (LSM).

### EXAMPLE EMBODIMENTS

Example 1: A device includes a first ionoelastomer membrane disposed over and locally spaced away from a second ionoelastomer membrane, the first and second ionoelastomer membranes defining at least a portion of a dielectric fluid-containing reservoir therebetween, a primary electrode overlying a portion of the first ionoelastomer membrane, and a secondary electrode overlying a portion of the second ionoelastomer membrane.

Example 2: The device of Example 1, where the first and second ionoelastomer membranes form a heterojunction.

Example 3: The device of any of Examples 1 and 2, where the first ionoelastomer membrane includes a crosslinked network of 1-ethyl-3-methyl imidazolium poly[(3-sulfopropyl) acrylate] (ES) and the second ionoelastomer membrane includes a crosslinked network of poly [1-(2-acryloyloxyethyl)-3-buthylimidazolium]bis(trifluoromethane) sulfonimide (AT).

Example 4: The device of any of Examples 1-3, where the first and second ionoelastomer membranes each directly overlie the dielectric fluid.

Example 5: The device of any of Examples 1-4, where the dielectric fluid includes silicone oil or a dielectric ester.

Example 6: The device of any of Examples 1-5, where at least one of the electrodes includes a conductive polymer.

Example 7: The device of any of Examples 1-6, where at least one of the electrodes includes microporous layer (MPL) carbon or doped polydimethylsiloxane.

Example 8: The device of any of Examples 1-7, where at least one of the electrodes includes a non-planar region.

Example 9: The device of any of Examples 1-8, further including a primary insulation layer overlying the primary electrode and a secondary insulation layer overlying the secondary electrode, where the primary and secondary insulation layers envelop the dielectric fluid-containing reservoir.

Example 10: A method includes applying a bias of less than approximately 50 V between the primary electrode and the secondary electrode of the device of any of Examples 1-9.

Example 11: The method of Example 10, where the applied bias induces a compressive pressure between the primary electrode and the secondary electrode of up to approximately 200 kPa.

Example 12: A method includes coupling motion of a haptic device to motion of a user, the haptic device including (a) a first ionoelastomer membrane disposed over and locally spaced away from a second ionoelastomer membrane, the first and second ionoelastomer membranes defining a dielectric fluid-containing reservoir therebetween, (b) a primary electrode overlying a portion of the first ionoelastomer membrane, and (c) a secondary electrode overlying a portion of the second ionoelastomer membrane, and applying a bias to at least one of the electrodes to actuate the haptic device and apply pressure or shear to a body part of the user.

Example 13: The method of Example 12, where the applied bias is less than approximately 50V.

Example 14: The method of any of Examples 12 and 13, where the haptic device includes a first portion located proximate to a first side of the joint and a second portion located proximate to a second side of the joint opposite to the first side, and actuating the haptic device includes applying a bias simultaneously to the first portion and the second portion.

Example 15: A wearable device includes a garment configured to be worn by a user of the wearable device, and a haptic assembly coupled to a portion of the garment, the haptic assembly including (a) a first ionoelastomer membrane disposed over and locally spaced away from a second ionoelastomer membrane, the first and second ionoelastomer membranes defining a dielectric fluid-containing reservoir therebetween (b) a primary electrode overlying a portion of the first ionoelastomer membrane, and (c) a secondary electrode overlying a portion of the second ionoelastomer membrane, where the haptic assembly is configured to impede movement of a body part of the user located proximate to the portion of the garment.

Example 16: The wearable device of Example 15, where the garment includes an article selected from a glove, a headband, an armband, a sleeve, a head covering, a sock, a shirt, and pants.

Example 17: The wearable device of any of Examples 15 and 16, where the haptic assembly is disposed proximate to a joint of the body part of the user.

Example 18: The wearable device of any of Examples 15-17, where (a) the haptic assembly is configured to substantially not impede movement of the body part while the haptic assembly is in an unactuated state, and (b) the haptic assembly is configured to substantially impede movement of the body part while the haptic assembly is in an actuated state.

Example 19: The wearable device of any of Examples 15-18, where the haptic assembly is configured to extend a joint of the body part of the user while the haptic assembly is in an actuated state.

Example 20: The wearable device of any of Examples 15-19, where the haptic assembly is configured to impede movement of the user's body part in response to a bias of less than approximately 50 V being applied between the primary electrode and the secondary electrode.

Example 21: A device includes a first ionoelastomer membrane disposed over and locally spaced away from a second ionoelastomer membrane, the first and second ionoelastomer membranes defining a dielectric fluid-containing reservoir therebetween, a primary electrode overlying a portion of the first ionoelastomer membrane, a secondary electrode overlying a portion of the second ionoelastomer membrane, and an insulative layer enveloping the first and second ionoelastomer membranes and the primary and secondary electrodes.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

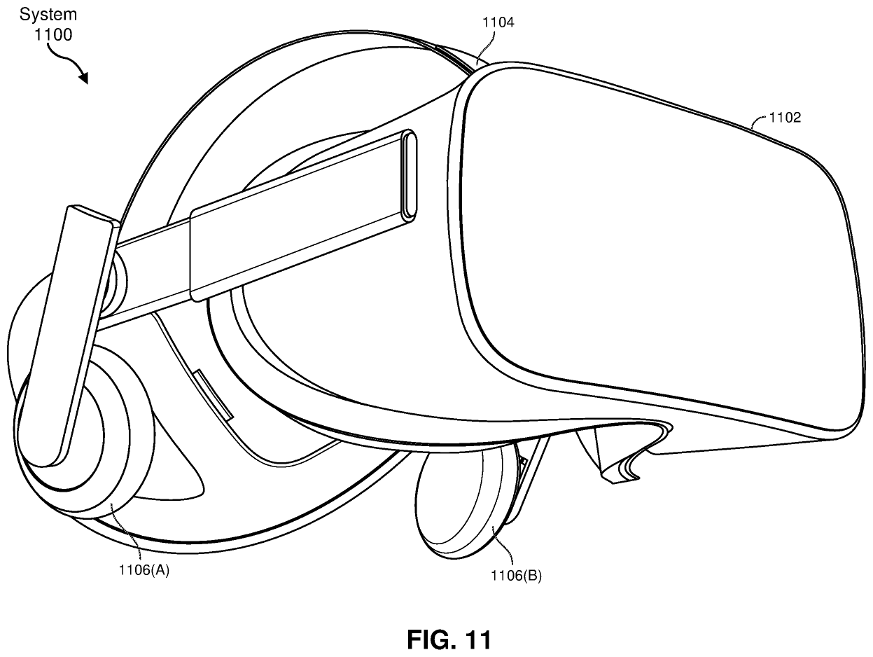

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 1000 in FIG. 10) or that visually immerses a user in an artificial reality (e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

Augmented-reality system 1000 may also include a microphone array with a plurality of acoustic transducers 1020(A)-1020(J), referred to collectively as acoustic transducers 1020. Acoustic transducers 1020 may be transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality device 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a Bluetooth connection). In still other embodiments, acoustic transducers 1020(A) and 1020(B) may not be used at all in conjunction with augmented-reality system 1000.

Acoustic transducers 1020 on frame 1010 may be positioned along the length of the temples, across the bridge, above or below display devices 1015(A) and 1015(B), or some combination thereof. Acoustic transducers 1020 may be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(1) and 1020(J)) that are part of the microphone array (or potentially form their own microphone subarray). Neckband 1005 may also include a controller 1025 and a power source 1035.

Acoustic transducers 1020(1) and 1020(J) of neckband 1005 may be configured to detect sound and convert the detected sound into an electronic format (analog or digital). In the embodiment of FIG. 10, acoustic transducers 1020(1) and 1020(J) may be positioned on neckband 1005, thereby increasing the distance between the neckband acoustic transducers 1020(1) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUS), one or more tracking emitters or detectors, and/or any other suitable device or system for creating an artificial reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 1000 and/or virtual-reality system 1100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 11, output audio transducers 1106(A) and 1106(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 10, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, creating digital art, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 1000 and 1100 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

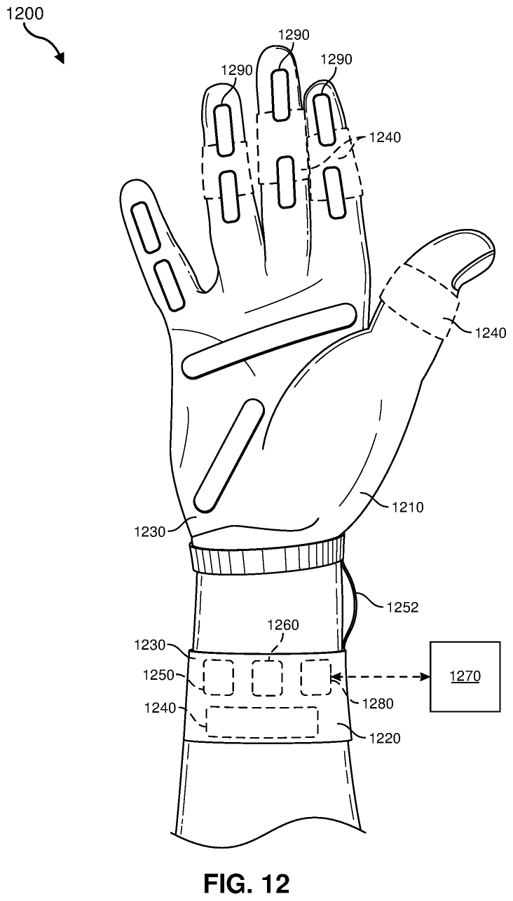

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 12 illustrates a vibrotactile system 1200 in the form of a wearable glove (haptic device 1210) and wristband (haptic device 1220). Haptic device 1210 and haptic device 1220 are shown as examples of wearable devices that include a flexible, wearable textile material 1230 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a wearable garment such as a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1240 may be positioned at least partially within one or more corresponding pockets formed in textile material 1230 of vibrotactile system 1200. Vibrotactile devices 1240 may be positioned in locations to provide a vibrating sensation (e.g., haptic feedback) to a user of vibrotactile system 1200. For example, vibrotactile devices 1240 may be positioned against the user's finger(s), thumb, or wrist, as shown in FIG. 12. Vibrotactile devices 1240 may, in some examples, be sufficiently flexible to conform to or bend with the user's corresponding body part(s). Vibrotactile devices 1240 may be configured to provide one or more of a shear effect, squeeze effect, kinesthetic effect, etc., and may include an actuator or a plurality of actuators as described herein in connection with FIGS. 4-8.

A power source 1250 (e.g., a battery) for applying a voltage to the vibrotactile devices 1240 for activation thereof may be electrically coupled to vibrotactile devices 1240, such as via conductive wiring 1252. In some examples, each of vibrotactile devices 1240 may be independently electrically coupled to power source 1250 for individual activation. In some embodiments, a processor 1260 may be operatively coupled to power source 1250 and configured (e.g., programmed) to control activation of vibrotactile devices 1240.

Vibrotactile system 1200 may be implemented in a variety of ways. In some examples, vibrotactile system 1200 may be a standalone system with integral subsystems and components for operation independent of other devices and systems. As another example, vibrotactile system 1200 may be configured for interaction with another device or system 1270. For example, vibrotactile system 1200 may, in some examples, include a communications interface 1280 for receiving and/or sending signals to the other device or system 1270. The other device or system 1270 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1280 may enable communications between vibrotactile system 1200 and the other device or system 1270 via a wireless (e.g., Wi-Fi, Bluetooth, cellular, radio, etc.) link or a wired link. If present, communications interface 1280 may be in communication with processor 1260, such as to provide a signal to processor 1260 to activate or deactivate one or more of the vibrotactile devices 1240.

Vibrotactile system 1200 may optionally include other subsystems and components, such as touch-sensitive pads 1290, pressure sensors, motion sensors, position sensors, lighting elements, and/or user interface elements (e.g., an on/off button, a vibration control element, etc.). During use, vibrotactile devices 1240 may be configured to be activated for a variety of different reasons, such as in response to the user's interaction with user interface elements, a signal from the motion or position sensors, a signal from the touch-sensitive pads 1290, a signal from the pressure sensors, a signal from the other device or system 1270, etc.

Although power source 1250, processor 1260, and communications interface 1280 are illustrated in FIG. 12 as being positioned in haptic device 1220, the present disclosure is not so limited. For example, one or more of power source 1250, processor 1260, or communications interface 1280 may be positioned within haptic device 1210 or within another wearable textile.

In some examples, the electrostatic zipping actuator may form a tactile interactive mechanism that may be incorporated into a wearable device. For example, such a tactile interactive mechanism may be positioned on or in a glove such that the electrostatic zipping actuator is positioned over or proximate to a joint portion of the glove. In additional examples, such tactile interactive mechanisms and electrostatic zipping actuators may be positioned in other locations in gloves or in other wearable devices.

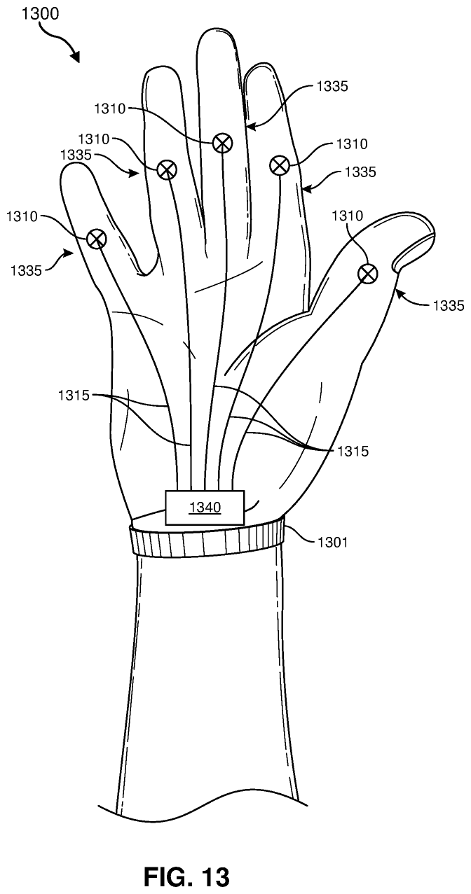

FIG. 13 is a perspective view of a wearable device 1300 in the form of a glove 1301, according to one implementation of the present disclosure. As shown in FIG. 13, the wearable device 1300 may include zipping actuators 1310 (e.g., a pair of electrostatic zipping actuators 710, 720) respectively positioned proximate to joint portions 1335 of the glove 1301 and configured to apply a localized pressure to the user's fingers when the wearable device 1300 is in use.

A control assembly 1340 configured to actuate zipping actuators 1310 may be coupled (e.g., electrically coupled) to the zipping actuators 1310, such as via respective conduits 1315. The zipping actuators 1310, conduits 1315, and control assembly 1340 may collectively form a kinesthetic interactive mechanism. According to some embodiments, in addition to, or in lieu of, zipping actuators 1310 positioned at joint portions 1335 of wearable device 1300, a wearable device such as glove 1301 may include zipping actuators located at other positions, such as the fingertips or proximate to the palm. Such zipping actuators, in combination with suitable conduits, control assemblies, etc., may form a tactile interactive mechanism or a shear interactive mechanism, for example.

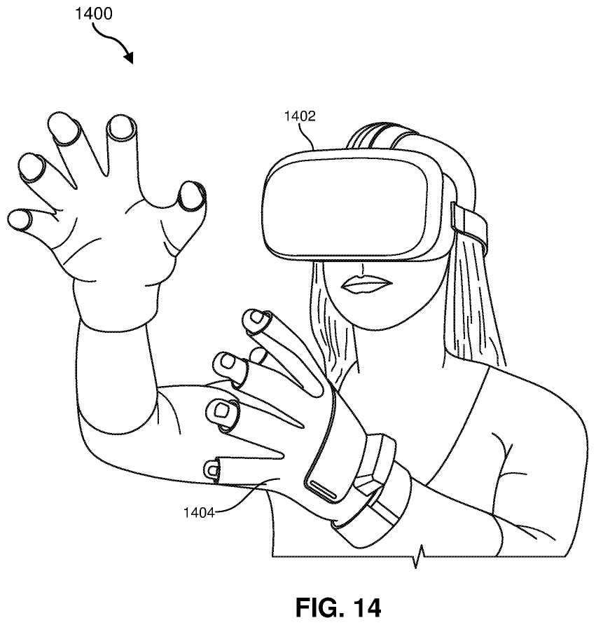

Haptic wearables, such as those shown in and described in connection with FIG. 12 and FIG. 13, may be implemented in a variety of types of artificial-reality systems and environments. FIG. 14 shows an example artificial-reality environment 1400 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1402 generally represents any type or form of virtual-reality system, such as virtual-reality system 1100 in FIG. 11. Haptic device 1404 generally represents any type or form of wearable device, worn by a user of an artificial-reality system, that provides haptic feedback to the user to give the user the perception that he or she is physically engaging with a virtual object. In some embodiments, haptic device 1404 may provide haptic feedback by applying vibration, motion, and/or force to the user. For example, haptic device 1404 may limit or augment a user's movement. To give a specific example, haptic device 1404 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1404 to send action requests to a console. Examples of action requests include, without limitation, requests to start an application and/or end the application and/or requests to perform a particular action within the application.

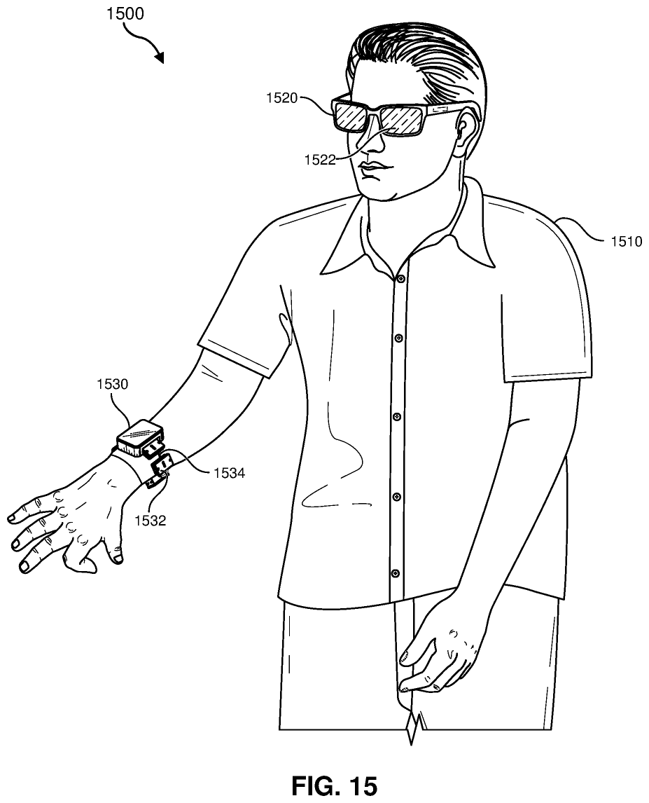

While haptic interfaces may be used with virtual-reality systems, as shown in FIG. 14, haptic interfaces may also be used with augmented-reality systems, as shown in FIG. 15. FIG. 15 is a perspective view of a user 1510 interacting with an augmented-reality system 1500. In this example, user 1510 may wear a pair of augmented-reality glasses 1520 that may have one or more displays 1522 and that are paired with a haptic device 1530. In this example, haptic device 1530 may be a wristband that includes a plurality of band elements 1532 and a tensioning mechanism 1534 that connects band elements 1532 to one another.

One or more of band elements 1532 may include any type or form of actuator suitable for providing haptic feedback. For example, one or more of band elements 1532 may be configured to provide one or more of various types of cutaneous feedback, including vibration, force, traction, texture, and/or temperature. To provide such feedback, band elements 1532 may include one or more of various types of actuators. In one example, each of band elements 1532 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1210, 1220, 1404, and 1530 may include any suitable number and/or type of haptic transducer, sensor, and/or feedback mechanism. For example, haptic devices 1210, 1220, 1404, and 1530 may include one or more mechanical transducers, piezoelectric transducers, and/or fluidic transducers. Haptic devices 1210, 1220, 1404, and 1530 may also include various combinations of different types and forms of transducers that work together or independently to enhance a user's artificial-reality experience. In one example, each of band elements 1532 of haptic device 1530 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

In some examples, any relational term, such as “first,” “second,” “upper,” “lower,” “on,” “over,” etc., may be used for clarity and convenience in understanding the disclosure and accompanying drawings and does not connote or depend on any specific preference, orientation, or order, except where the context clearly indicates otherwise.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a dielectric fluid that comprises or includes silicone oil include embodiments where a dielectric fluid consists essentially of silicone oil and embodiments where a dielectric fluid consists of silicone oil.

What is claimed is:

1. A device comprising:
a first ionoelastomer membrane disposed over and locally spaced away from a second ionoelastomer membrane, the first and second ionoelastomer membranes defining at least a portion of a dielectric fluid-containing reservoir therebetween;
a primary electrode overlying a portion of the first ionoelastomer membrane; and
a secondary electrode overlying a portion of the second ionoelastomer membrane.

2. The device of claim 1, wherein the first and second ionoelastomer membranes form a heterojunction.

3. The device of claim 1, wherein the first ionoelastomer membrane comprises a crosslinked network of 1-ethyl-3-methyl imidazolium poly[(3-sulfopropyl) acrylate] (ES) and the second ionoelastomer membrane comprises a crosslinked network of poly [1-(2-acryloyloxyethyl)-3-buthylimidazolium]bis(trifluoromethane) sulfonimide (AT).

4. The device of claim 1, wherein the first and second ionoelastomer membranes each directly overlie the dielectric fluid.

5. The device of claim 1, wherein the dielectric fluid comprises silicone oil or a dielectric ester.

6. The device of claim 1, wherein at least one of the electrodes comprises a conductive polymer.

7. The device of claim 1, wherein at least one of the electrodes comprises microporous layer (MPL) carbon or doped polydimethylsiloxane.

8. The device of claim 1, wherein at least one of the electrodes comprises a non-planar region.

9. The device of claim 1, further comprising:
a primary insulation layer overlying the primary electrode; and
a secondary insulation layer overlying the secondary electrode, wherein the primary and secondary insulation layers envelop the dielectric fluid-containing reservoir.

10. A method comprising:
applying a bias of less than approximately 50 V between the primary electrode and the secondary electrode of the device of claim 1.

11. The method of claim 10, wherein the applied bias induces a compressive pressure between the primary electrode and the secondary electrode of up to approximately 200 kPa.

12. A method comprising:
coupling motion of a haptic device to motion of a user, the haptic device comprising (a) a first ionoelastomer membrane disposed over and locally spaced away from a second ionoelastomer membrane, the first and second ionoelastomer membranes defining a dielectric fluid-containing reservoir therebetween, (b) a primary electrode overlying a portion of the first ionoelastomer membrane, and (c) a secondary electrode overlying a portion of the second ionoelastomer membrane; and
applying a bias to at least one of the electrodes to actuate the haptic device and apply pressure or shear to a body part of the user.

13. The method of claim 12, wherein the applied bias is less than approximately 50 V.

14. The method of claim 12, wherein:
the haptic device comprises a first portion located proximate to a first side of a joint of the body part and a second portion located proximate to a second side of the joint opposite to the first side; and
actuating the haptic device comprises applying a bias simultaneously to the first portion and the second portion.

15. A wearable device comprising:
a garment configured to be worn by a user of the wearable device; and
a haptic assembly coupled to a portion of the garment, the haptic assembly comprising:
a first ionoelastomer membrane disposed over and locally spaced away from a second ionoelastomer membrane, the first and second ionoelastomer membranes defining a dielectric fluid-containing reservoir therebetween;
a primary electrode overlying a portion of the first ionoelastomer membrane; and
a secondary electrode overlying a portion of the second ionoelastomer membrane, wherein the haptic assembly is configured to impede movement of a body part of the user located proximate to the portion of the garment.

16. The wearable device of claim 15, wherein the garment comprises an article selected from the group consisting of a glove, a headband, an armband, a sleeve, a head covering, a sock, a shirt, and pants.

17. The wearable device of claim 15, wherein the haptic assembly is disposed proximate to a joint of the body part of the user.

18. The wearable device of claim 15, wherein (a) the haptic assembly is configured to substantially not impede movement of the body part while the haptic assembly is in an unactuated state, and (b) the haptic assembly is configured to substantially impede movement of the body part while the haptic assembly is in an actuated state.

19. The wearable device of claim 15, wherein the haptic assembly is configured to extend a joint of the body part of the user while the haptic assembly is in an actuated state.

20. The wearable device of claim 15, wherein the haptic assembly is configured to impede movement of the user's body part in response to a bias of less than approximately 50 V being applied between the primary electrode and the secondary electrode.
